(19) United States
(12) Patent Application Publication
(10) Pub. No.: US 2025/0289492 A1
(43) Pub. Date: Sep. 18, 2025

(54) Detachable Stearing Wheel Cover

(71) Applicant: Michael Williams, Hobart, IN (US)

(72) Inventor: Michael Williams, Hobart, IN (US)

(21) Appl. No.: 18/604,137

(22) Filed: Mar. 13, 2024

(51) Int. Cl. B62D 1/06

(52) U.S. Cl. CPC B62D 1/06

(57) ABSTRACT

A detachable steering wheel cover includes a circular body and securing structures. The circular body has a substantially C-shaped cross-sectional profile and is designed to surround more than 50% of the circumference of a steering wheel of a vehicle. The circular body may be pressed onto the steering wheel of a vehicle with the circular slot facing away from a user and toward a dashboard of a vehicle. The cover is removable to permit use on different steering wheels when the user drives different vehicles temporarily.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to driving accessories and more particularly pertains to a new detachable steering wheel cover, which could be used in situations in which a driver is temporarily in a vehicle, such as a rental car, fleet vehicle, or other shared private or commercial vehicle. For example, in the commercial trucking industry, “slip seating” is a common practice in which drivers are not assigned a specific truck to use for a business, but rather switch between different trucks. Such routine switching can be uncomfortable for drivers that are used to the particular feel and operation of one truck. In addition, such routine switching could be unhygienic if other users are ill or simply have been in contact with germs and bacteria, as it is well known that hand contact is one of the most common means to transfer germs and bacteria.

### (2) Description of Related Art including information disclosed under 37 CFR 1.97 and 1.98.

The prior art relates to driving accessories. The prior art, as best understood, does not disclose detachable steering wheel cover that has a circular body with a circular slot that faces away from the user and toward a dashboard of a vehicle, such as a tractor trailer, rental car, fleet vehicle, or other shared private or commercial vehicle, when the circular body has been pressed onto a steering wheel.

### BRIEF SUMMARY OF THE INVENTION

An embodiment of the disclosure meets the needs presented above in a detachable steering wheel cover generally comprising a circular body and securing structures. The circular body has a substantially C-shaped cross-sectional profile and is designed to surround more than 50% of the circumference of a steering wheel of a vehicle. The circular body includes a circular slot having a width less than the cross-sectional diameter of a steering wheel of a vehicle. The circular body includes an interior edge portion and an exterior edge portion positioned on opposite sides of the circular slot. The circular body includes a resilient flexible material designed to permit the interior edge portion and the exterior edge portion to be temporarily displaced away from one another when the circular body is pressed onto a steering wheel of a vehicle with the circular slot facing away from a user and toward a dashboard of a vehicle. The securing structures are positioned at intervals about the circular body and designed to provide a securing force on a steering wheel of a vehicle. The interior edge portion includes recesses designed and positioned to accommodate spokes of a steering wheel of a vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a detachable steering wheel cover according to an embodiment of the disclosure.

FIG. 2 is a rear perspective view of an embodiment of the disclosure.

FIG. 3 is a perspective view of an embodiment of the disclosure in use.

FIG. 4 is a front view of an embodiment of the disclosure in use.

FIG. 5 is a cross-sectional view of an embodiment of the disclosure in use.

FIG. 6 is a rear perspective view of an embodiment of the disclosure in use.

### DETAILED DESCRIPTION OF THE INVENTION

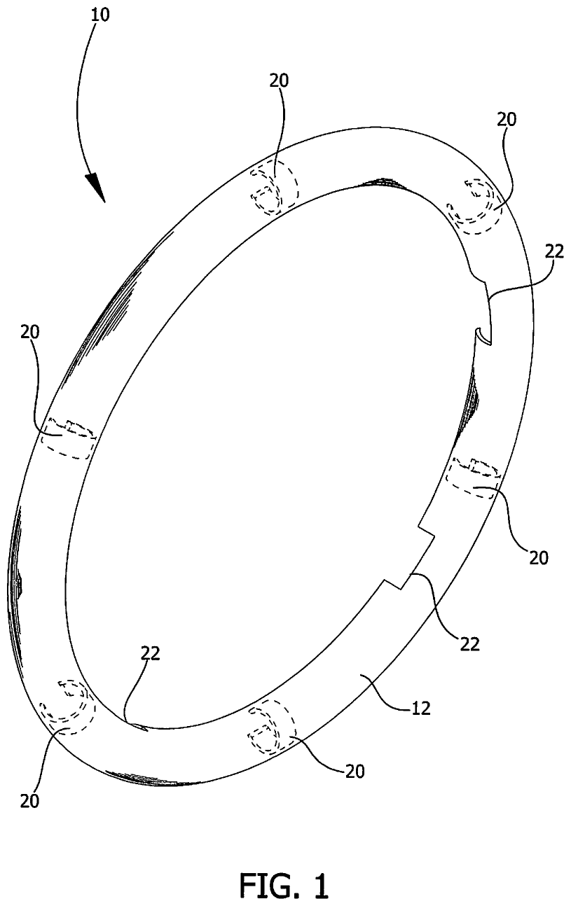

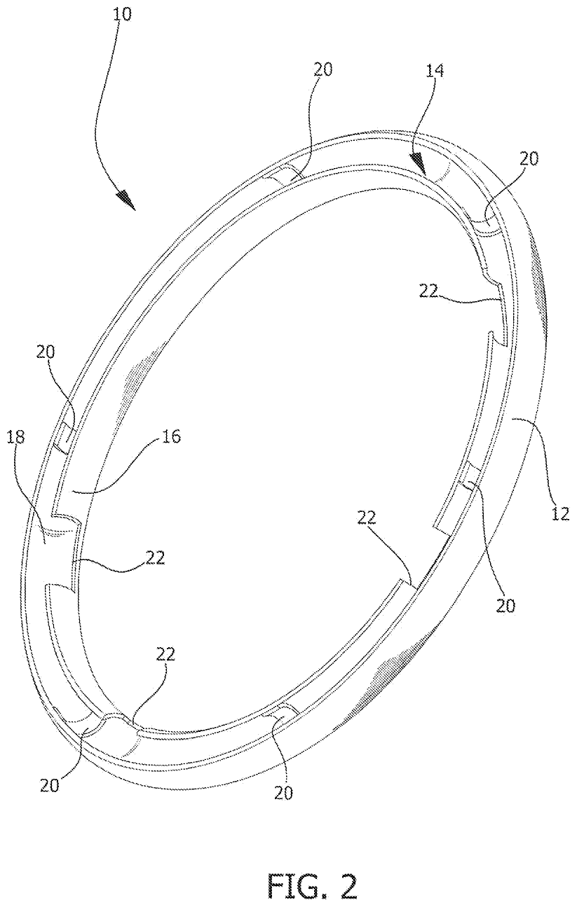

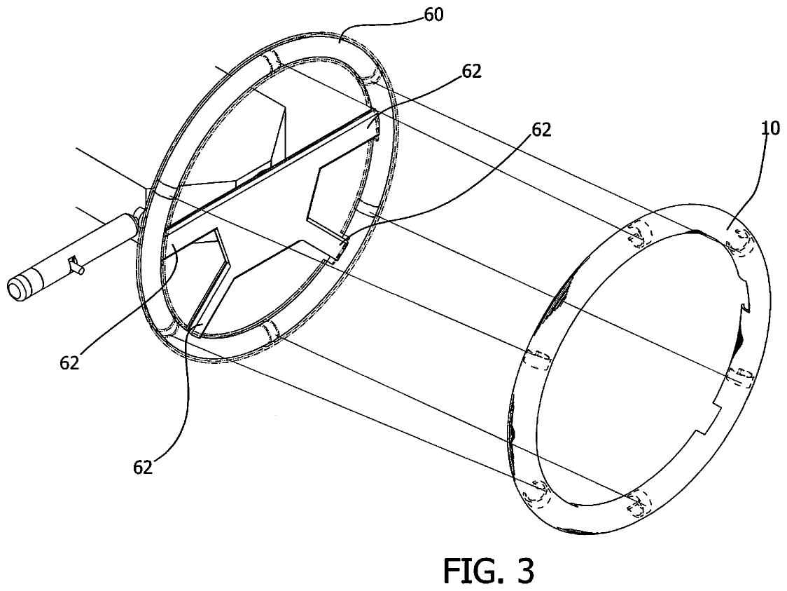

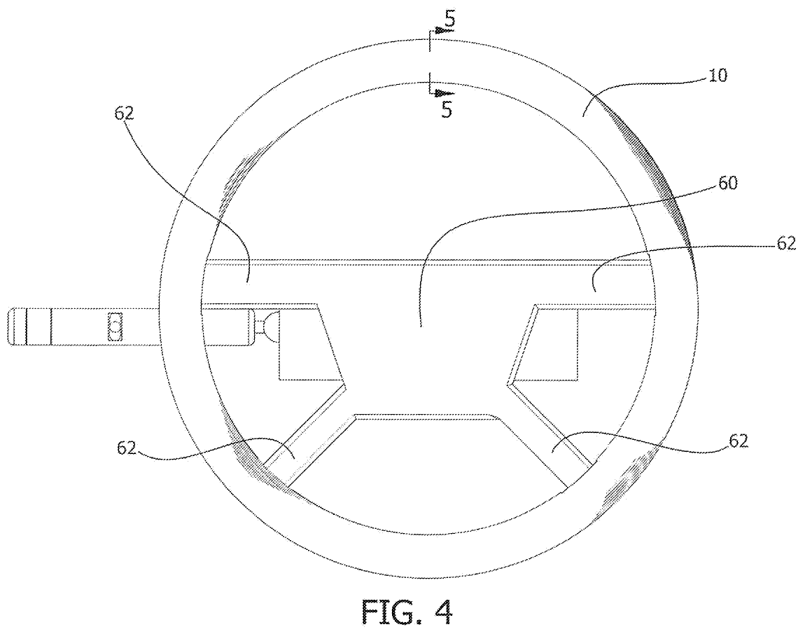

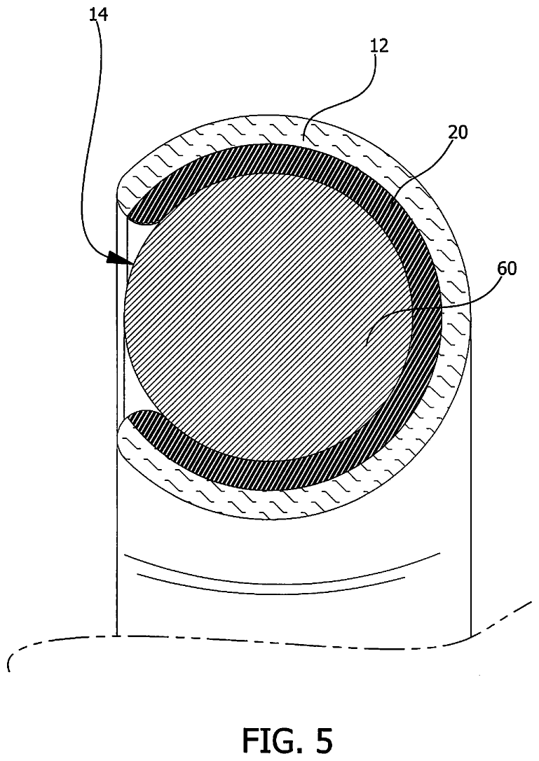

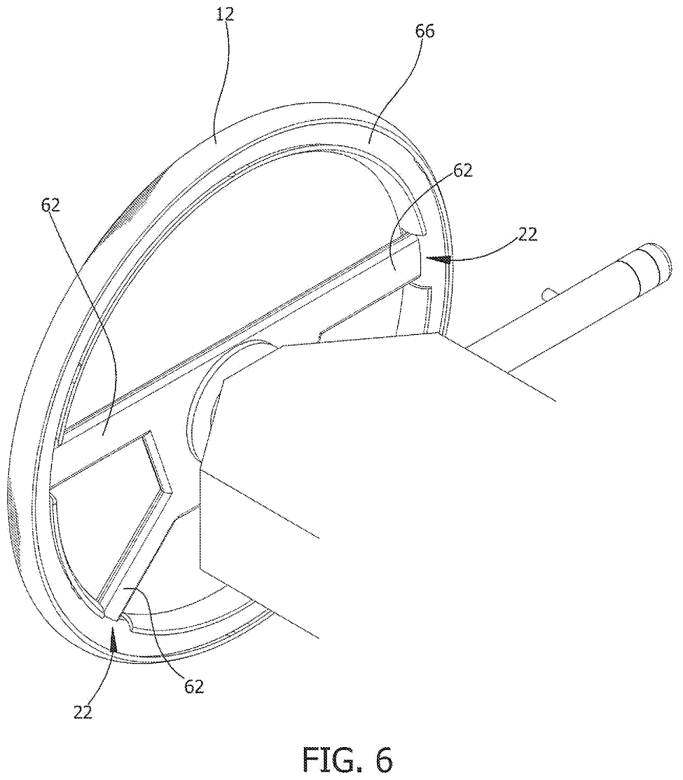

With reference now to the drawings, and in particular to FIGS. 1 through 6 thereof, a new detachable steering wheel cover embodying the principles and concepts of an embodiment of the disclosure and generally designated by the reference numeral 10 will be described.

As best illustrated in FIGS. 1 through 6, the detachable steering wheel cover 10 generally comprises a circular body 12 and securing structures, which in the embodiment shown are in the form of retaining clips 20, though it should be understood that other types of securing structures are within the scope of the disclosure. The circular body 12 has a substantially C-shaped cross-sectional profile and is designed to surround more than 50% of the circumference of a steering wheel 60 of a vehicle. The circular body 12 includes a circular slot 14 having a width less than the cross-sectional diameter of a steering wheel 60 of a vehicle. The circular body 12 includes an interior edge portion 16 and an exterior edge portion 18 positioned on opposite sides of the circular slot 14. The circular body 12 includes a resilient flexible material designed to permit the interior edge portion 16 and the exterior edge portion 18 to be temporarily displaced away from one another when the circular body 12 is pressed onto a steering wheel 60 of a vehicle with the circular slot 14 facing away from a user and toward a dashboard of a vehicle. The securing structures are positioned at intervals about the circular body 12 and designed to provide a securing force on a steering wheel 60 of a vehicle. The interior edge portion 16 includes recesses 22 designed and positioned to accommodate spokes 62 of a steering wheel 60 of a vehicle.

In accordance with at least one possible embodiment, the retaining clips 20 are substantially C-shaped and designed to detachably connect to a steering wheel 60 of a vehicle in snap-fit manner.

In accordance with at least one possible embodiment, the retaining clips 20 are mounted on or integrally flush with an interior surface of the circular body 12. In other words, the retaining clips 20 are seated on top of the interior surface of the circular body 12 and support the circular body 12 a distance from the steering wheel itself, such that the retaining clips 20 are the only portion of the detachable steering wheel cover 10 in contact with the steering wheel. Alternatively, the retaining clips 20 are formed integrally into the circular body 12 and thus are flush with the interior surface thereof. In this design, essentially the entire circular body 12 is in contact with the steering wheel 60.

In accordance with at least one possible embodiment, the resilient flexible material includes rubber or plastic or a combination thereof having sufficient hardness to permit the circular body 12 to detachably connect to a steering wheel 60 of a vehicle in snap-fit manner.

In accordance with at least one possible embodiment, the circular body 12 is designed to surround more than 60% of the circumference of a steering wheel 60 of a vehicle.

In accordance with at least one possible embodiment, the circular body 12 is designed to surround more than 70% of the circumference of a steering wheel 60 of a vehicle. It should be understood that the circular body 12 could be designed to cover anywhere in the range between greater than 50% to 85% or more of the circumference of a steering wheel 60 of a vehicle, including 1% increments in this range.

In order to use the detachable steering wheel cover 10, the user first orients the circular body 12 with the circular slot 14 facing away from the user and toward the steering wheel of the vehicle to be driven by the user. The user then aligns the circular slot 14 with the steering wheel, and also aligns the recesses 22 with the spokes 62 of the steering wheel. Once aligned, the user presses the circular body 12 away from the user and onto the steering wheel via the circular slot 14 such that the circular body 12 surrounds more than 50% of the circumference of the steering wheel. The user can then grip the circular body 12 while driving the vehicle and use the steering wheel in a normal manner. Once the user is done driving, the circular body 12 can be removed from the steering wheel. The user can then repeat these steps with each different vehicle. In this manner the user can use essentially his own steering wheel no matter what vehicle he is driving temporarily.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A detachable steering wheel cover comprising:
a circular body having a substantially C-shaped cross-sectional profile and being configured to surround more than 50% of the circumference of a steering wheel of a vehicle;
said circular body comprising a circular slot having a width less than the cross-sectional diameter of a steering wheel of a vehicle;
said circular body comprising an interior edge portion and an exterior edge portion disposed on opposite sides of said circular slot;
said circular body comprising a resilient flexible material in a continuous circle configured to permit said interior edge portion and said exterior edge portion to be temporarily displaced away from one another upon said circular body being pressed onto a steering wheel of a vehicle with said circular slot facing away from a user and toward a dashboard of a vehicle;
securing structures coupled to said circular body and being disposed at intervals about said circular body and configured to provide a securing force on a steering wheel of a vehicle; and
said interior edge portion comprising recesses configured and disposed to accommodate spokes of a steering wheel of a vehicle.

2. The detachable steering wheel cover of claim 1, wherein said securing structures comprise retaining clips that are substantially C-shaped and configured to detachably connect to a steering wheel of a vehicle in snap-fit manner.

3. The detachable steering wheel cover of claim 2, wherein said retaining clips are mounted on or integrally flush with an interior surface of said circular body.

4. The detachable steering wheel cover of claim 3, wherein said resilient flexible material comprises rubber or plastic or a combination thereof having sufficient hardness to permit said circular body to detachably connect to a steering wheel of a vehicle in snap-fit manner.

5. The detachable steering wheel cover of claim 4, wherein said circular body is configured to surround more than 60% of the circumference of a steering wheel of a vehicle.

6. The detachable steering wheel cover of claim 5, wherein said circular body is configured to surround more than 70% of the circumference of a steering wheel of a vehicle.

7. The detachable steering wheel cover of claim 1, wherein said resilient flexible material comprises rubber or plastic or a combination thereof having sufficient hardness to permit said circular body to detachably connect to a steering wheel of a vehicle in snap-fit manner.

8. The detachable steering wheel cover of claim 1, wherein said circular body is configured to surround more than 60% of the circumference of a steering wheel of a vehicle.

9. The detachable steering wheel cover of claim 1, wherein said circular body is configured to surround more than 70% of the circumference of a steering wheel of a vehicle.

10. (canceled)

11. (canceled)

12. (canceled)
